(19) United States
(12) Patent Application Publication
(10) Pub. No.: US 2013/0118744 A1
(43) Pub. Date: May 16, 2013

(54) Self-Degrading High Temperature Stable Gel for Downhole Applications

(71) Applicant: Halliburton Energy Services, Inc. ("HESI"), Duncan, OK (US)

(72) Inventors: Pubudu H. GAMAGE, Katy, TX (US); Jay P. Deville, Spring, TX (US)

(73) Assignee: Halliburton Energy Services, Inc. ("HESI"), Duncan, OK (US)

(21) Appl. No.: 13/725,968

(22) Filed: Dec. 21, 2012

Related U.S. Application Data
(63) Continuation-in-part of application No. 13/297,663, filed on Nov. 16, 2011.

(51) Int. Cl. E21B 33/13; C09K 8/00

(52) U.S. Cl. CPC E21B 33/13; C09K 8/00
USPC 166/293; 507/226

(57) ABSTRACT

A method of treating a subterranean formation including providing a treatment fluid comprising an aqueous carrier fluid, a crosslinking agent, a pH-adjusting agent, and a terpolymer that comprises 2-acrylamido-2-methylpropanesulfonic acid, acrylamide, and acrylic acid monomer units, or any salt thereof, where the treatment fluid does not include any gel stabilizers, or only minimal amounts of gel stabilizers. The treatment fluid is introduced into a subterranean formation and is allowed to form a gel in the subterranean formation. The gel is broken, without using an external breaker, after the gel has been in the subterranean formation for at least about one day.

### APPLICATIONS

This application is a continuation-in-part (CIP) of U.S. Non-Provisional patent application Ser. No. 13/297,663, filed on Nov. 16, 2011, the entire contents of which are incorporated by reference herein.

### BACKGROUND

The present invention generally relates to the use of gellable treatment fluids in subterranean operations, and, more specifically, to the use of gellable treatment fluids comprising gelling agents and crosslinking agents, and methods of using these treatment fluids in high-temperature subterranean operations.

Treatment fluids can be employed in a variety of subterranean operations. As used herein the terms “treatment,” “treating,” other grammatical equivalents thereof refer to any subterranean operation that uses a fluid in conjunction with performing a desired function and/or for achieving a desired purpose. The terms “treatment,” “treating,” and other grammatical equivalents thereof do not imply any particular action by the fluid or any component thereof. Illustrative subterranean operations that can be performed using treatment fluids can include, for example, drilling operations, fracturing operations, sand control operations, gravel packing operations, acidizing operations, conformance control operations, fluid diversion operations, fluid blocking operations, and the like.

In many cases, treatment fluids can be utilized in a gelled state when performing a treatment operation. For example, in a fracturing operation, a treatment fluid can be gelled to increase its viscosity and improve its ability to carry a proppant or other particulate material. In other cases, a gelled treatment fluid can be used to temporarily divert or block the flow of fluids within at least a portion of a subterranean formation. In the case of fracturing operations, the gelled treatment fluid typically spends only a very short amount of time downhole before the gel is broken and the treatment fluid is produced from the wellbore. In fluid diversion or blocking operations, the gel typically needs to remain in place only for a short amount of time while another treatment fluid is flowed elsewhere in the subterranean formation.

When conducting subterranean operations, it can sometimes become necessary to block the flow of fluids in the subterranean formation for a prolonged period of time, typically for at least about one day or more. In some cases, the period of time can be much longer, days or weeks. For example, it can sometimes be desirable to impede the flow of formation fluids for extended periods of time by introducing a kill pill or perforation pill into the subterranean formation to at least temporarily cease the communication between wellbore and reservoir. As used herein, the terms “kill pill” and “perforation pill” refer to a small amount of a treatment fluid introduced into a wellbore that blocks the ability of formation fluids to flow into the wellbore. In kill pill and perforation pill applications, high density brines can be particularly effective as a carrier fluid, since they can form a highly viscous gel that blocks the flow of fluids within the wellbore by exerting hydrostatic pressure therein. Likewise, in fluid loss applications, it can sometimes be desirable to form a barrier within the wellbore that persists for an extended period of time.

For subterranean operations requiring extended downhole residence times, many gelled treatment fluids can prove unsuitable since they can break before their intended downhole function is completed. The premature break of gelled treatment fluids can be particularly problematic in high temperature subterranean formations (e.g., formations having a temperature of about 275° F. or above), where the elevated formation temperature decreases the gel stability and speeds gel decomposition. As subterranean operations are being conducted in deeper wellbores having ever higher formation temperatures, the issues with long-term gel stability are becoming an increasingly encountered issue as existing gels are being pushed to their chemical and thermal stability limits.

Traditionally, the decomposition of a gel into lower viscosity fluids may be accomplished by using a breaker. An external breaker may be needed to remove a fluid loss pill upon well completion. Breaker compounds useful in high temperature formations may have high corrosion rates and may be harmful to the formation. Further, one may incur additional costs and utilize extra time to add the external breaker to the formation. Additionally, operators usually prefer to use a self-degrading pill instead of a pill needing an external breaker. Therefore, a need exists for self-degrading, high temperature stable, gellable treatment fluids useful in subterranean operations.

### BRIEF DESCRIPTION OF THE DRAWINGS

The following figures are included to illustrate certain aspects of the present invention, and should not be viewed as exclusive embodiments. The subject matter disclosed is capable of considerable modification, alteration, and equivalents in form and function, as will occur to one having ordinary skill in the art and having the benefit of this disclosure.

FIG. 1 shows an illustrative plot of Gel Degradation Curves as a function of time for treatment fluids having varying amounts of gel stabilizers, where the gel was set at 320° F. and 500 psi.

FIG. 2 shows an illustrative plot of Gel Degradation Curves as a function of time for treatment fluids having varying amounts of gel stabilizers, where the gel was set at 350° F. and 500 psi.

### DETAILED DESCRIPTION

In some embodiments of the present invention, a method of treating a subterranean formation comprises providing a treatment fluid comprising an aqueous carrier fluid, a crosslinking agent, a pH-adjusting agent, and a terpolymer that comprises 2-acrylamido-2-methylpropanesulfonic acid, acrylamide, and acrylic acid monomer units, or any salt thereof, with the proviso that the treatment fluid does not include any gel stabilizers; introducing the treatment fluid into a subterranean formation; allowing the treatment fluid to form a gel in the subterranean formation; and allowing the gel to break, without using an external breaker, after the gel has been in the subterranean formation for at least about one day.

In certain embodiments of the present invention, a method of treating a subterranean formation comprises providing a treatment fluid comprising an aqueous carrier fluid, a crosslinking agent, a pH-adjusting agent, and a terpolymer that comprises 2-acrylamido-2-methylpropanesulfonic acid, acrylamide, and acrylic acid monomer units, or any salt thereof, with the proviso that the treatment fluid only includes a minimal amount of gel stabilizers; introducing the treatment fluid into a subterranean formation; allowing the treatment fluid to form a gel in the subterranean formation; and allowing the gel to break, without using an external breaker, after the gel has been in the subterranean formation for at least about one day. In some embodiments, “minimal amount” of gel stabilizers means less than about 0.05% by volume of the treatment fluid.

The present disclosure utilizes gellable treatment fluids that form thermally stable gels in a subterranean formation that can persist for extended periods of time at high formation temperatures (e.g., greater than about 275° F.). More particularly, the gellable treatment fluids of the present disclosure can comprise a terpolymer that comprises 2-acrylamido-2-methylpropanesulfonic acid, acrylamide, and acrylic acid monomer units or any of its salts and crosslinking agent, where the terpolymer and the crosslinking agent form a gel downhole, and the gellation can be initiated or accelerated by the formation temperature. The crosslinking rate can be further accelerated or decelerated, as desired, by using gellation accelerators or retarders, respectively, such that the gel can be formed in a desired location within the subterranean formation. Since the treatment fluids can be introduced to the subterranean formation in an ungelled state, significant issues due to friction pressure are not typically encountered. Once in the subterranean formation, the gellable treatment fluids can form a crosslinked gel therein that does not flow under in situ stress after placement. As used herein, the term “in situ stress” refers to shearing forces present within a subterranean formation, including, for example, manmade shear produced during subterranean operations and naturally occurring shear forces present within the subterranean formation. The crosslinked gels of the current embodiments are to be distinguished from other uses of the present terpolymer in subterranean operations, where a linear gel results from treatment with the crosslinking agent, but the gel remains sufficiently fluid that it does flow under low shear stress and is readily pumped downhole. In some embodiments, formation of a crosslinked gel can be promoted by using higher concentrations of crosslinking agent than have typically been employed with the above terpolymer. In some embodiments, the terpolymer can become fully crosslinked in the presence of a crosslinking agent. As used herein, the terms “full crosslinking,” “complete crosslinking,” and grammatical equivalents thereof will refer to an amount of crosslinking that achieves a viscosity that cannot be substantially further increased by increasing the amount of crosslinking agent.

One of the advantages of some embodiments of the present invention is the ability to treat subterranean formations having temperatures as high as 350° F. without the treatment fluids becoming substantially unstable. Another potential advantage associated with some embodiments of the present invention may include the ability to delay the crosslinking of the treatment fluid until after the fluid has been introduced into a subterranean formation. Such a delay may help to avoid high friction pressure and gel shear degradation prior to introduction into the formation. Yet another potential advantage of some embodiments of the present invention may include the ability to tailor the activation temperature for the crosslinking reaction by the addition of one or more crosslinking delaying agents. Other advantages may be evident to one skilled in the art.

Before the crosslinking reaction occurs, the treatment fluids of the present invention may comprise an aqueous base fluid; a gelling agent comprising a terpolymer of 2-acrylamido-2-methylpropane sulfonic acid, acrylamide, and acrylic acid or a salt thereof; and a crosslinking agent. After the crosslinking reaction occurs, a treatment fluid in accordance with the present invention may comprise an aqueous base fluid and a reaction product of a gelling agent comprising a terpolymer of 2-acrylamido-2-methylpropane sulfonic acid, acrylamide, and acrylic acid or a salt thereof and a crosslinking agent.

In some embodiments, the treatment fluids of the present invention do not include gel stabilizers and do not require the use of external breakers. In certain embodiments, the aqueous carrier fluid is present in the amount of from about 85% to about 98.4% by volume of the treatment fluid, the terpolymer is present in the amount of from about 1% to about 10% by volume of the treatment fluid, the crosslinking agent is capable of crosslinking the terpolymer and is present in the amount of from about 0.1% to about 5% by volume of the treatment fluid, and the pH-adjusting agent is present in the amount of from about 0.5% to about 5% by volume of the treatment fluid.

In another embodiment, a method of treating a subterranean formation comprises providing a treatment fluid comprising an aqueous carrier fluid in the amount of from about 85% to about 98.4% by volume of the treatment fluid, a crosslinking agent in the amount of from about 0.1% to about 5% by volume of the treatment fluid, a pH-adjusting agent in the amount of from about 0.5% to about 5% by volume of the treatment fluid, and a terpolymer that comprises 2-acrylamido-2-methylpropanesulfonic acid, acrylamide, and acrylic acid monomer units, or any salt thereof in the amount of from about 1% to about 10% by volume of the treatment fluid, with the proviso that the treatment fluid does not include any gel stabilizers; introducing the treatment fluid into a subterranean formation; allowing the treatment fluid to form a gel in the subterranean formation; and breaking the gel, without using an external breaker, after the gel has been in the subterranean formation for at least about one day.

In some embodiments, the treatment fluids of the present invention include a minimal amount of gel stabilizers and do not require the use of external breakers. In certain embodiments, the aqueous carrier fluid is present in the amount of from about 85% to about 98.4% by volume of the treatment fluid, the terpolymer is present in the amount of from about 1% to about 10% by volume of the treatment fluid, the crosslinking agent is capable of crosslinking the terpolymer and is present in the amount of from about 0.1% to about 5% by volume of the treatment fluid, the gel stabilizer is present in the amount of less than about 0.05% by volume of the treatment fluid, and the pH-adjusting agent is present in the amount of from about 0.5% to about 5% by volume of the treatment fluid.

In other embodiments, a method of treating a subterranean formation comprises providing a treatment fluid comprising an aqueous carrier fluid in the amount of from about 85% to about 98.4% by volume of the treatment fluid, a crosslinking agent in the amount of from about 0.1% to about 5% by volume of the treatment fluid, a pH-adjusting agent in the amount of from about 0.5% to about 5% by volume of the treatment fluid, a gel stabilizer in the amount of less than about 0.05% by volume of the treatment fluid and a terpolymer that comprises 2-acrylamido-2-methylpropanesulfonic acid, acrylamide, and acrylic acid monomer units, or any salt thereof in the amount of from about 1% to about 10% by volume of the treatment fluid; introducing the treatment fluid into a subterranean formation; allowing the treatment fluid to form a gel in the subterranean formation; and allowing the gel to break, without using an external breaker, after the gel has been in the subterranean formation for at least about one day.

In some embodiments, the crosslinked gel can at least partially block the flow of formation fluids from at least a portion of the subterranean formation. In some embodiments, treatment fluids described herein can substantially block the flow of fluids (e.g., formation fluids) from a subterranean formation. For purposes of this disclosure, “substantially block” means block essentially all of the flow of fluids. For example, in kill pill and perforation pill applications, a complete blocking of fluid flow can be desirable.

Aqueous Carrier Fluids

The aqueous carrier fluid of the present embodiments can generally be from any source, provided that the fluids do not contain components that might adversely affect the stability and/or performance of the treatment fluids of the present invention. In various embodiments, the aqueous carrier fluid can comprise fresh water, acidified water, salt water, seawater, brine, or an aqueous salt solution. In some embodiments, the aqueous carrier fluid can comprise a monovalent brine or a divalent brine. Suitable monovalent brines can include, for example, sodium chloride brines, sodium bromide brines, potassium chloride brines, potassium bromide brines, and the like. Suitable divalent brines can include, for example, magnesium chloride brines, calcium chloride brines, calcium bromide brines, and the like. In some embodiments, the aqueous carrier fluid can be a high density brine. As used herein, the term “high density brine” refers to a brine that has a density of about 10 lbs/gal or greater (1.2 g/cm³ or greater). It is believed that the formation of gels in such high density brines can be particularly problematic due to polymer hydration issues. However, gelled treatment fluids formed from high density brines can be particularly advantageous for kill pill and other fluid loss applications due to the significant hydrostatic pressure exerted by the weight of the gel.

In some embodiments, the aqueous carrier fluid is present in the treatment fluid the amount of from about 85% to about 98.4% by volume of the treatment fluid. In another embodiment, the aqueous carrier fluid is present in the amount of from about 90% to about 98% by volume of the treatment fluid. In further embodiments, the aqueous carrier fluid is present in the amount of from about 94% to about 98% by volume of the treatment fluid.

Terpolymers

Treatment fluids of the present invention also comprise a gelling agent including one or more synthetic polymers containing carboxylate groups. In some embodiments, the synthetic polymer comprises a terpolymer of 2-acrylamido-2-methylpropane sulfonic acid, acrylamide, and acrylic acid or salts thereof. As used herein, the term “terpolymer” refers to a polymer that results from the copolymerization of three discrete monomers, while the term “polymer” refers to a chemical compound formed by polymerization and consisting essentially of repeating structural units. The terpolymer of 2-acrylamido-2-methylpropane sulfonic acid, acrylamide, and acrylic acid or salts thereof is believed to hydrate in the presence of water to form a gel that can be rapidly cross-linked by metal ions.

The terpolymer used in the present embodiments can have a composition spanning a wide range. In general, an amount of 2-acrylamido-2-methylpropanesulfonic acid monomer units in the terpolymer can range between about 10% and about 80% of the terpolymer by weight, and an amount of acrylic acid monomer units in the terpolymer can range between about 0.1% and about 10% of the terpolymer by weight, with the balance comprising acrylamide monomer units. In more particular embodiments, the terpolymer can comprise between about 55% and about 65% 2-acrylamido-2-methylpropanesulfonic acid monomer units by weight, between about 34.9% and about 44.9% acrylamide monomer units by weight, and between about 0.1% and about 10.1% acrylic acid monomer units by weight. In still more particular embodiments, the terpolymer can comprise between about 55% and about 65% 2-acrylamido-2-methylpropanesulfonic acid monomer units by weight, between about 34.9% and about 49.9% acrylamide monomer units by weight, and between about 0.1% and about 5.1% acrylic acid monomer units by weight.

In various embodiments, an amount of the terpolymer present in the treatment fluids is from about 1% to about 10% by volume of the treatment fluid. In some embodiments, an amount of the terpolymer present in the treatment fluids is from about 3% to about 10% by volume of the treatment fluid. In further embodiments, an amount of the terpolymer present in the treatment fluids is from about 5% to about 10% by volume of the treatment fluid. In additional embodiments, an amount of the terpolymer present in the treatment fluids is from about 7% to about 10% by volume of the treatment fluid.

Crosslinking Agents

The treatment fluids of the present invention also include at least one crosslinking agent to crosslink at least a portion of the molecules of the polymer to form a crosslinked polymer. As used herein, the term “crosslinking agent” includes any molecule, atom, or ion that is capable of forming one or more crosslinks between molecules of the crosslinkable polymer and/or between two or more atoms in a single molecule of the crosslinkable polymer. The term “crosslink” as used herein refers to a covalent or ionic bond that links one polymer chain to another.

A variety of crosslinking agents can be used in accordance with the present embodiments. In some embodiments, the crosslinking agent can be a metal ion. Metal ions suitable to serve as crosslinking agents in the present embodiments can include, for example, titanium (IV) ions, zirconium (IV) ions, chromium (III) ions, cobalt (III) ions, aluminum (III) ions, hafnium (III) ions, and the like. In some embodiments, the crosslinking agent can comprise zirconyl chloride or zirconyl sulfate. In some embodiments, a metal ion-releasing compound such as a coordination compound can be used. In some embodiments, the crosslinking agent can be an organic crosslinking agent such as, for example, a diamine, dithiol or a diol. In some embodiments, the crosslinking agent can be an organic polymer such as, for example, a polyester, a polyalkyleneimine (e.g., polyethyleneimine) or a polyalkylenepolyamine. Having the benefit of the present disclosure and knowing the temperature and chemistry of a subterranean formation of interest, one having ordinary skill in the art will be able to choose a crosslinking agent and amount thereof suitable for producing a desired gel time and viscosity.

In some embodiments, mixtures of crosslinking agents can be used to achieve a desired rate of crosslinking. For example, in some embodiments, a crosslinking agent that produces a slower rate of crosslinking can be added as a gellation retarder, and in other embodiments, a crosslinking agent that produces a faster rate of crosslinking can be added as a gellation accelerator. In some embodiments, a gellation retarder or a gellation accelerator can, respectively, increase or decrease the temperature at which gellation takes place. In some embodiments, a metal ion-containing crosslinking agent can contain various concentrations of acetate and lactate, which will determine whether the added crosslinking agent serves as a gellation retarder or a gellation accelerator. Appropriate amounts of acetate and lactate ions to be added to a metal ion-containing crosslinking agent to serve as either a gellation retarder or gellation accelerator can be determined through routine experimentation by one having ordinary skill in the art. Other agents that can be added to control the rate and/or temperature of gellation can include, for example, other α-hydroxy acids (e.g., glycolic acid, tartaric acid and the like), diols and polyols.

Generally, the crosslinking agent is present in the current treatment fluids in an amount sufficient to provide a desired degree of crosslinking of the terpolymer. In some embodiments, the amount of crosslinking agent present can be sufficient to achieve complete crosslinking, although incomplete crosslinking may be more preferable in other embodiments. In certain embodiments, the crosslinking agent is present in an amount of less than about 5% by volume of the treatment fluid. In other embodiments, the crosslinking agent is present in an amount of less than about 3% by volume of the treatment fluid. In some embodiments, the crosslinking agent is present in the amount of from about 0.1% to about 5% by volume of the treatment fluid. In certain embodiments, the crosslinking agent is present in the amount of from about 0.1% to about 3% by volume of the treatment fluid. In further embodiments, the crosslinking agent is present in the amount of from about 0.1% to about 2% by volume of the treatment fluid. In other embodiments, the crosslinking agent is present in the amount of from about 1% to about 3% by volume of the treatment fluid.

In order to form a gel having a suitable temperature stability and viscosity profile, an amount of the terpolymer to the crosslinking agent is typically maintained at a concentration ratio of at most about 10:1. In some embodiments, an amount of the terpolymer to the crosslinking agent can be maintained at a concentration ratio of at most about 6:1. In some embodiments, a concentration ratio of the terpolymer to the crosslinking agent can range between about 6:1 and about 2:1. In other embodiments, a concentration ratio of the terpolymer to the crosslinking agent can range between about 6:1 and about 1:1.

pH-Adjusting Agents

In some embodiments, the treatment fluids of the present invention may also include a pH-adjusting agent. Examples of suitable pH-adjusting agents include, but are not limited to, sulfamic acid, hydrochloric acid, sulfuric acid, and sodium bisulfate. In some embodiments, the pH-adjusting agent may be selected so as not to compete with the gelling agent for metal ions provided by the crosslinking agent. In some embodiments, the present treatment fluids can have a pH ranging between about 3 and about 6 prior to gel formation occurring. In other embodiments, the treatment fluids can have a pH ranging between about 1 and about 5. In still other embodiments, the treatment fluids can have a pH ranging between about 4 and about 5. In some embodiments, the pH of the fully formulated pill is between about 1 and about 5 before spotting. Lowering of the pH may increase the breaking time. Different pH values for the formulations can be use depending on the required holding time of the fluid loss pill. In some embodiments, the present treatment fluids can further comprise a buffer to maintain the pH of the treatment fluid within a desired range, including within any of the above ranges. When used, the buffer should be chosen such that it does not interfere with the formation of a gel within the subterranean formation. In various embodiments, the pH-adjusting agent is present in the amount of from about 0.5% to about 5% by volume of the treatment fluid. In some embodiments, the pH-adjusting agent is present in the amount of from about 2% to about 5% by volume of the treatment fluid. In certain embodiments, the pH-adjusting agent is present in the amount of from about 3% to about 5% by volume of the treatment fluid.

In some embodiments, the pH of the treatment fluid can be further adjusted with a pH-modifying agent such as, for example, an acid or a base. Reasons why one would want to adjust the pH of the treatment fluid can include, for example, to adjust the rate of hydration of the terpolymer, to activate the crosslinking agent, to improve the properties of the gel formed from the copolymer, to adjust the rate of gellation of the terpolymer, and any combination thereof.

In high temperature formations having a temperature of about 280° F. or greater, the present treatment fluids can undergo gellation simply by exposure to the formation temperatures. In subterranean formations having a temperature of about 200° F. to about 275° F., it can be more desirable, and oftentimes necessary, to accelerate the gellation rate by formulating the crosslinking agent as a gellation accelerator. At these lower temperatures, the gellation rate can either be sluggish, or a gel can fail to form. Divalent brines are more likely to be used in higher temperatures because pressures would generally be higher and divalents afford the higher densities needed to counterbalance that pressure. Divalent brines, but not monovalent brines, can sometimes be incompatible with the terpolymer due to precipitation and other instability issues, particularly as the formation temperature approaches and exceeds 300° F. Under these conditions, the gel can experience mechanical failure in a very short time in the presence of a divalent brine. At lower formation temperatures (e.g., less than about 250° F.), however, divalent brines can be successfully used with the terpolymer without substantial precipitation occurring. As previously noted, crosslinking can be extremely slow to non-existant at these lower temperatures. Use of a gellation accelerator to accelerate the crosslinking rate can enable the use of divalent brines in these embodiments.

In certain embodiment, the treatment fluids and methods of the present invention do not contain gel stabilizers, and thus do not utilize any of the following compounds as gel stabilizers. In other embodiments, the treatment fluids of the present invention may include minimal amounts of gel stabilizers. Examples of gel stabilizers useful in the invention include antioxidants. Antioxidants can include, for example, a sulfite salt (e.g., sodium sulfite), ascorbic acid, erythorbic acid, a hydroquinone, any salt thereof, any derivative thereof, or any combination thereof. Other antioxidants can be envisioned by one having ordinary skill in the art such as, tannic acid, gallic acid, propyl gallate, thiols, and the like. In some embodiments, the gel stabilizers are present in an amount of less than about 0.05% by volume of the treatment fluid. One of skill in the art will also realize that certain embodiments of the treatment fluids of the present invention could contain CFS-563 (an oxygen scavenger with sodium erythorbate in an aqueous solution of isopropylhydroxylamine, available from Halliburton, Houston, Tex.), or BARASCAV D (an oxygen scavenger available from Halliburton, Houston, Tex.), or combinations thereof in an amount of less than about 0.05% by volume of the treatment fluid.

The treatment fluids and methods of the present invention do not use external breakers, and thus do not utilize any of the following compounds as external breakers. The following is a list of external breakers that other fluids have used. Examples of external breakers include an oxidizer such as, for example, sodium bromate, sodium chlorate, metal persulfates or manganese dioxide. Other breakers can comprise a treatment fluid having a pH of about 7 or greater, which can cause gels formed to collapse. External breakers can be present in a treatment fluid as a delayed-release breaker. A breaker can be formulated for delayed release by encapsulating the breaker in a material that is slowly soluble or slowly degradable in the treatment fluid or the gel formed therefrom. Illustrative materials that can be used for encapsulation can include, for example, porous materials (e.g., precipitated silica, alumina, zeolites, clays, hydrotalcites, and the like), EPDM rubber, polyvinylidene chloride, polyamides, polyurethanes, crosslinked and partially hydrolyzed acrylate polymers, and the like. Degradable polymers can be used to encapsulate a breaker. One specific external breaker is “VICON FB,” which is a breaker available from Halliburton Energy Services.

In addition to the foregoing materials, it can also be desirable, in some embodiments, for other components to be present in the treatment fluid. Such additional components can include, without limitation, particulate materials, fibrous materials, bridging agents, weighting agents, proppants, gravel, corrosion inhibitors, catalysts, clay control stabilizers, biocides, bactericides, friction reducers, gases, surfactants, solubilizers, salts, scale inhibitors, corrosion inhibitors, foaming agents, anti-foaming agents, iron control agents, and the like.

The treatment fluids of the present invention may be prepared by any method suitable for a given application. For example, certain components of the treatment fluid of the present invention may be provided in a pre-blended powder or a dispersion of powder in a nonaqueous liquid, which may be combined with the aqueous base fluid at a subsequent time. In preparing the treatment fluids of the present invention, the pH of the aqueous base fluid may be adjusted, among other purposes, to facilitate the hydration of the gelling agent. The pH range in which the gelling agent will readily hydrate may depend upon a variety of factors (e.g., the components of the gelling agent, etc.) that will be recognized by one skilled in the art. This adjustment of pH may occur prior to, during, or subsequent to the addition of the gelling agent and/or other components of the treatment fluids of the present invention. After the preblended liquids and the aqueous base fluid have been combined crosslinking agents and other suitable additives may be added prior to introduction into the well bore. Those of ordinary skill in the art, with the benefit of this disclosure will be able to determine other suitable methods for the preparation of the treatments fluids of the present invention.

The methods of the present invention may be employed in any subterranean treatment where a viscoelastic treatment fluid may be used. Suitable subterranean treatments may include, but are not limited to, fracturing treatments, sand control treatments (e.g., gravel packing), and other suitable treatments where a treatment fluid of the present invention may be suitable. In one embodiment, the present invention provides a method of treating a portion of a subterranean formation comprising providing a treatment fluid comprising an aqueous base fluid; a gelling agent comprising a terpolymer of 2-acrylamido-2-methylpropane sulfonic acid, acrylamide, and acrylic acid or a salt thereof; and a crosslinking agent capable of crosslinking the terpolymer; and introducing the treatment fluid into a subterranean formation. In another embodiment, the present invention provides a method of fracturing a subterranean formation comprising providing a treatment fluid comprising an aqueous base fluid; a gelling agent comprising terpolymer of 2-acrylamido-2-methylpropane sulfonic acid, acrylamide, and acrylic acid or a salt thereof; and a crosslinking agent capable of crosslinking the terpolymer; and introducing the treatment fluid into a subterranean formation at a pressure sufficient to create or enhance at least one fracture within the subterranean formation.

In some embodiments, the present treatment fluids can be used in a subterranean formation having a temperature of up to about 350° F. In some embodiments, the present treatment fluids can be used in a subterranean formation having a temperature of up to about 320° F. In some embodiments, the present treatment fluids can be used in a subterranean formation having a temperature ranging between about 175° F. and about 350° F. In some embodiments, the present treatment fluids can be used in a subterranean formation having a temperature ranging between about 200° F. and about 350° F. In some embodiments, the present treatment fluids can be used in a subterranean formation having a temperature ranging between about 250° F. and about 350° F. In some embodiments, the present treatment fluids can be used in a subterranean formation having a temperature ranging between about 275° F. and about 350° F. In some embodiments, the present treatment fluids can be used in a subterranean formation having a temperature ranging between about 300° F. and about 350° F. In some embodiments, the present treatment fluids can be used in a subterranean formation having a temperature ranging between about 320° F. and about 350° F.

In some embodiments, gels made by the present invention can keep their integrity for at least about 3 days when used in a subterranean formation having a temperature of up to about 350° F. In certain embodiments, gels made by the present invention can keep their integrity for at least about 2 days when used in a subterranean formation having a temperature of up to about 350° F. In various embodiments, gels made by the present invention essentially fully degrade in at least about 6 days when used in a subterranean formation having a temperature of up to about 350° F. In some embodiments, gels made by the present invention essentially fully degrade in at least about 4 days when used in a subterranean formation having a temperature of up to about 350° F. In certain embodiments, “essentially fully degrade” means that the percentage of gellation has dropped below about 10%.

In some embodiments, gels made by the present invention can keep their integrity for at least about 6 days when used in a subterranean formation having a temperature of up to about 320° F. In certain embodiments, gels made by the present invention can keep their integrity for at least about 4 days when used in a subterranean formation having a temperature of up to about 320° F. In various embodiments, gels made by the present invention essentially fully degrade in at least about 12 days when used in a subterranean formation having a temperature of up to about 320° F. In some embodiments, gels made by the present invention essentially fully degrade in at least about 8 days when used in a subterranean formation having a temperature of up to about 320° F.

Depending on the function that the present treatment fluids are performing, one having ordinary skill in the art will be able to determine an appropriate length of time for the gel to remain in the subterranean formation prior to being broken. In some embodiments, gels formed from the present treatment fluids can be broken after the gel has been in the subterranean formation for at least about one day. In some embodiments, the gel can be broken after at least about two days in the subterranean formation, or after at least about three days in the subterranean formation, or after at least about four days in the subterranean formation, or after at least about five days in the subterranean formation, or after at least about seven days in the subterranean formation, or after at least about ten days in the subterranean formation, or after at least about fifteen days in the subterranean formation. In some embodiments, the gel can be broken after being in the subterranean formation for a time ranging between about one day and about two days, or between about two days and about three days, or between about three days and about four days, or between about four days and about five days, or between about five days and about seven days, or between about seven days and about ten days, or between about ten days and about fifteen days. The foregoing ranges represent the native break rate of the gel without adding an external breaker.

In some subterranean operations, it can be desirable to leave the gels in the subterranean formation for a shorter length of time. In some embodiments, gels formed from present treatment fluids can be allowed to remain in the subterranean formation for less than about one day. For example, the gels can be allowed to remain in the subterranean formation for about 16 hours or less, or about 14 hours or less, or about 12 hours or less, or about 10 hours or less, or about 8 hours or less, or about 6 hours or less, or about 4 hours or less, or about 2 hours or less before being broken.

The exemplary self-degrading high temperature stable gels disclosed herein may directly or indirectly affect one or more components or pieces of equipment associated with the preparation, delivery, recapture, recycling, reuse, and/or disposal of the disclosed self-degrading high temperature stable gels. For example, the disclosed self-degrading high temperature stable gels may directly or indirectly affect one or more mixers, related mixing equipment, mud pits, storage facilities or units, fluid separators, heat exchangers, sensors, gauges, pumps, compressors, and the like used to generate, store, monitor, regulate, and/or recondition the exemplary self-degrading high temperature stable gels. The disclosed self-degrading high temperature stable gels may also directly or indirectly affect any transport or delivery equipment used to convey the self-degrading high temperature stable gels to a well site or downhole such as, for example, any transport vessels, conduits, pipelines, trucks, tubulars, and/or pipes used to fluidically move the self-degrading high temperature stable gels from one location to another, any pumps, compressors, or motors (e.g., topside or downhole) used to drive the self-degrading high temperature stable gels into motion, any valves or related joints used to regulate the pressure or flow rate of the self-degrading high temperature stable gels, and any sensors (i.e., pressure and temperature), gauges, and/or combinations thereof, and the like. The disclosed self-degrading high temperature stable gels may also directly or indirectly affect the various downhole equipment and tools that may come into contact with the chemicals/fluids such as, but not limited to, drill string, coiled tubing, drill pipe, drill collars, mud motors, downhole motors and/or pumps, floats, MWD/LWD tools and related telemetry equipment, drill bits (including roller cone, PDC, natural diamond, hole openers, reamers, and coring bits), sensors or distributed sensors, downhole heat exchangers, valves and corresponding actuation devices, tool seals, packers and other wellbore isolation devices or components, and the like.

### EXAMPLES

The invention having been generally described, the following examples are given as particular embodiments of the invention and to demonstrate the practice and advantages hereof. It is understood that the examples are given by way of illustration and are not intended to limit the specification or the claims to follow in any manner.

### Example 1

Fluid Preparation

A 10 lb/gal NaBr brine is formulated by diluting 280 mL of 12.5 lb/gal NaBr stock brine with 420 mL of 8.345 lb/gal deionized water. The diluted brine is placed in an appropriately sized container and sheared at moderate speed with a paddle mixer. The rotation speed of the mixer is adjusted such that it creates a nice, deep vortex without whipping laboratory air into the fluid.

3% (v/v), or 11.1 lb/bbl of a mixture containing a 50 wt. % mineral oil dispersion of a terpolymer of a sodium salt of 2-acrylamido-2-methylpropanesulfonic acid, acrylamide, and acrylic acid was quickly added to the brine with rapid stirring. The terpolymer may become fully hydrated within about 60 seconds using a low to moderate applied shear. The vortex will close while viscosity builds rapidly; it may reach its maximum viscosity in less than 5 minutes. If the solution appears lumpy after terpolymer addition, continue to stir until the majority of the areas of high terpolymer concentration have been dispersed.

Before addition of the crosslinking agent, the pH of the terpolymer solution must be adjusted down to 2.5-3.0 by the addition of the appropriate amount of a freshly prepared aqueous sulfamic acid solution. This step generally requires the addition of 0.45% (v/v) or 1.57 lb/bbl of a freshly prepared 15% wt./vol. sulfamic acid solution.

1% (v/v), or 3.5 lb/bbl of “CL-40” (a Zr (IV) crosslinking agent composition containing 70-90% active crosslinking agent that is available from Halliburton, Houston, Tex.), is quickly added to the terpolymer solution with stirring. The viscosity of the fluid will increase rapidly; adjust the rotation speed of the mixer as needed to discourage the solution from climbing the mixing shaft. Ensure that the crosslinking agent is fully dispersed before proceeding. The pH of the fluid should be between about 6 and about 7.

For comparison, gel stabilizers were also added to the above fluid after the crosslinking agent was incorporated, to form a normal kill pill with full stabilizers. The additional gel stabilizers include CFS-563 (an oxygen scavenger with sodium erythorbate in an aqueous solution of isopropylhydroxylamine, available from Halliburton, Houston, Tex.), and BARASCAV D (an oxygen scavenger available from Halliburton, Houston, Tex.). After all components were added, the pH was adjusted a second time with the 15% wt./vol. sulfamic acid solution to produce a final pH ranging between 4.2 and 4.8, unless otherwise noted.

TABLE 1
(Normal Kill Pill Composition with Full Stabilizers)

| Compound | Amount |
|---|---|
| Terpolymer solution | 11.1 lb/bbl |
| Crosslinking agent | 3.5 lb/bbl |
| CFS-563 | 1 lb/bbl |
| BARASCAV D | 0.5 lb/bbl |
| pH-adjusting agent | Adjust the pH between |
| | 4-5 |

Additional compositions were prepared using ½, ¼, and ⅛ by weight of the amount of gel stabilizers. One of skill in the art will also realize that certain embodiments of the treatment fluids of the present invention could contain CFS-563 in an amount of less than about 0.05% by volume of the treatment fluid.

Gellation of the Treatment Fluids

Prior to gellation, the treatment fluids prepared as above were either allowed to rest overnight or were placed in a reduced pressure environment to reduce entrained air therein. Thereafter, aliquots of the treatment fluids were transferred to glass jars and placed in stainless steel aging cells, which were then sealed and purged with nitrogen gas several times before pressurizing to 500 psi and heating in an oven at 320° F. to promote gellation. The procedure was also carried out with a different set of samples at 350° F. After a pre-determined aging time, the aging cells were removed from the oven, rapidly cooled, depressurized and opened. Each sample was assayed qualitatively for gel viscosity and other properties by either turning the jar on its side or upside down and noting the gel's resistance to flow. Photographs of the treatment fluids of Example 1 after aging at 320° F. and 350° F. provide a qualitative measure of the stability of the gel formed during high temperature aging.

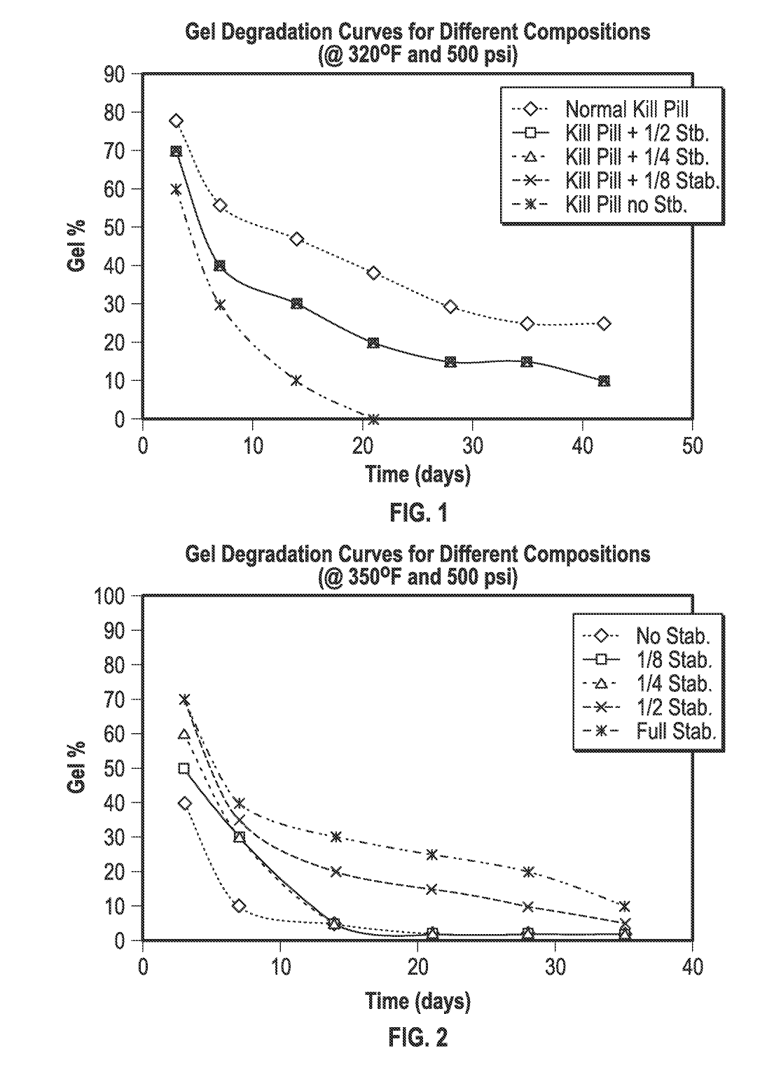

FIGS. 1 and 2 illustrate the Gel Degradation Curves for a Kill Pill according to the invention (0% gel stabilizers) as well as a Kill Pill with various concentrations of gel stabilizers after aging at either 320° F. (FIG. 1) or 350° F. (FIG. 2). A “Kill Pill No Stab.” is a self-degrading gel with no gel stabilizers. A “Full Stab./Normal Kill Pill” is a gel with gel stabilizers according to the formulation in Table 1. A “Kill Pill+½, ¼, ⅛ Stab.” is a gel according to the formulation in Table 1 with different concentrations of gel stabilizers. One of skill in the art will see that the treatment fluids of the present invention are self-degrading when used in high temperature formations and do not require the use of gel stabilizers, or only utilize minimal amounts of gel stabilizers.

While preferred embodiments of the invention have been shown and described, modifications thereof can be made by one skilled in the art without departing from the spirit and teachings of the invention. The embodiments described herein are exemplary only, and are not intended to be limiting. Many variations and modifications of the invention disclosed herein are possible and are within the scope of the invention. Use of the term “optionally” with respect to any element of a claim is intended to mean that the subject element is required, or alternatively, is not required. Both alternatives are intended to be within the scope of the claim.

Numerous other modifications, equivalents, and alternatives, will become apparent to those skilled in the art once the above disclosure is fully appreciated. It is intended that the following claims be interpreted to embrace all such modifications, equivalents, and alternatives where applicable.

What is claimed is:

1. A method comprising:
providing a treatment fluid comprising an aqueous carrier fluid, a crosslinking agent, a pH-adjusting agent, and a terpolymer that comprises 2-acrylamido-2-methylpropanesulfonic acid, acrylamide, and acrylic acid monomer units, or any salt thereof, with the proviso that the treatment fluid does not include any gel stabilizers;
introducing the treatment fluid into a subterranean formation;
allowing the treatment fluid to form a gel in the subterranean formation; and
allowing the gel to break, without using an external breaker, after the gel has been in the subterranean formation for at least about one day.

2. The method of claim 1, wherein the subterranean formation is at a temperature ranging between about 275° F. and about 350° F.

3. The method of claim 1, wherein the gel comprises a crosslinked gel that, after formation, at least partially blocks the flow of formation fluids from at least a portion of the subterranean formation.

4. The method of claim 1, wherein the gel comprises a crosslinked gel that, after formation, substantially blocks the flow of formation fluids from the subterranean formation.

5. The method of claim 1, wherein the aqueous carrier fluid is present in the amount of from about 85% to about 98.4% by volume of the treatment fluid.

6. The method of claim 1, wherein the crosslinking agent is present in the amount of from about 0.1% to about 5% by volume of the treatment fluid.

7. The method of claim 1, wherein the terpolymer is present in the amount of from about 1% to about 10% by volume of the treatment fluid.

8. The method of claim 1, wherein the pH-adjusting agent is present in the amount of from about 0.5% to about 5% by volume of the treatment fluid.

9. A method comprising:
providing a treatment fluid comprising an aqueous carrier fluid, a crosslinking agent, a pH-adjusting agent, a gel stabilizer present in the amount of less than about 0.05% by volume of the treatment fluid, and a terpolymer that comprises 2-acrylamido-2-methylpropanesulfonic acid, acrylamide, and acrylic acid monomer units, or any salt thereof;
introducing the treatment fluid into a subterranean formation;
allowing the treatment fluid to form a crosslinked gel in the subterranean formation that, after formation, at least partially blocks the flow of formation fluids from at least a portion of the subterranean formation; and
allowing the crosslinked gel to break, without using an external breaker, after it has been in the subterranean formation for at least about one day.

10. The method of claim 9, wherein the gel comprises a crosslinked gel that, after formation, substantially blocks the flow of formation fluids from the subterranean formation.

11. The method of claim 9, wherein the gel stabilizer is present in the amount of about 0% by volume of the treatment fluid.

12. The method of claim 9, wherein the subterranean formation is at a temperature ranging between about 175° F. and about 350° F.

13. The method of claim 9, wherein the treatment fluid has a pH ranging between about 1 and about 5.

14. The method of claim 9, wherein the aqueous carrier fluid is present in the amount of from about 85% to about 98.4% by volume of the treatment fluid, the crosslinking agent is present in the amount of from about 0.1% to about 5% by volume of the treatment fluid, the terpolymer is present in the amount of from about 1% to about 10% by volume of the treatment fluid, and the pH-adjusting agent is present in the amount of from about 0.5% to about 5% by volume of the treatment fluid.

15. The method of claim 9, wherein the crosslinked gels keep their integrity for at least about 3 days when used in a subterranean formation having a temperature of up to about 350° F.

16. The method of claim 9, wherein the crosslinked gels keep their integrity for at least about 6 days when used in a subterranean formation having a temperature of up to about 320° F.

17. The method of claim 9, wherein the crosslinked gels essentially fully degrade in at least about 6 days when used in a subterranean formation having a temperature of up to about 350° F.

18. A treatment fluid comprising:
an aqueous carrier fluid present in the amount of from about 85% to about 98.4% by volume of the treatment fluid;
a terpolymer that comprises 2-acrylamido-2-methylpropanesulfonic acid, acrylamide, and acrylic acid monomer units, or any salt thereof, present in the amount of from about 1% to about 10% by volume of the treatment fluid;
a crosslinking agent capable of crosslinking the terpolymer, present in the amount of from about 0.1% to about 5% by volume of the treatment fluid;
a pH-adjusting agent present in the amount of from about 0.5% to about 5% by volume of the treatment fluid, and
a gel stabilizer present in the amount of less than about 0.05% by volume of the treatment fluid.

19. The treatment fluid of claim 18, wherein the treatment fluid can undergo gellation at a temperature ranging between about 275° F. and about 350° F.

20. The treatment fluid of claim 18, wherein the amount of gel stabilizer is about 0% by volume of the treatment fluid.
